(19) United States
(12) Patent Application Publication
(10) Pub. No.: US 2014/0233126 A1
(43) Pub. Date: Aug. 21, 2014

(54) REFLECTIVE COLOR FILTER

(71) Applicants: SUZHOU UNIVERSITY, Suzhou JI (CN); SVG OPTRONICS, CO. LTD, Suzhou, (CN)

(72) Inventors: Yan Ye, Sozhou (CN); Linsen Chen, Suzhou (CN)

(73) Assignees: SUZHOU UNIVERSITY, Suzhou JI (CN); SVG OPTRONICS, CO. LTD., Suzhou JI (CN)

(21) Appl. No.: 14/123,142

(22) PCT Filed: May 31, 2011
(86) PCT No.: PCT/CN2011/074961

§ 371 Date: Apr. 28, 2014

(51) Int. Cl. G02B 5/26

(52) U.S. Cl. CPC G02B 5/26
USPC 359/885

(57) ABSTRACT

A reflective color filter comprises a medium grating layer (220), a metal layer (230), and a first medium layer (240). The metal layer is provided on the ridge portion, at least one side portion, and a part of the groove portion of the medium grating layer. The first medium layer reflecting outside light is provided on the medium grating layer and the metal layer. Because a part of the medium grating layer is exposed through an opening of the metal layer on the groove portion, the angular sensitivity of the resonance output is reduced, and the influence of the incident angle on the resonance condition is diminished. Therefore, a reflection filtering can be realized in a wide angular area.

### FIELD OF THE INVENTION

The present invention relates to an optical element used for filtering light and, more specifically, to a reflective color filter with grating structure.

### BACKGROUND OF THE INVENTION

Color filter (CF) can be divided into three kinds: reflective color filters, transmissive color filters and semi-reflective, semi-transmissive color filters, used in different applications respectively. Among which, reflective color filters may be used on electronic products needing front light source or external light source, such as electronic paper, mobile phone screens. Unlike transmissive color filters, in addition to considering the color purity, the efficiency of the surface reflection of the material should also be considered for reflective color filters. So there are certain requirements to the flatness and optical property of the material.

At present, there are two types of reflective filters classified by filtering principle, one is the dye-based color filter, the other is the grating-type color filter. The former is produced by preparing organic materials of three colors of R, G and B onto a transparent substrate by such methods as photolithography, printing, or deposition. The color filter of this type needs the three different organic materials to be formed successively on the substrate in the production, thus having such defects as uneven thickness and poor color purity; besides, because of complexity of the process steps, the production cost is extremely high, making the color filter particularly disadvantageous in its application to the large-sized panels. The latter can be divided according its composition, into a single-layer metal grating structure, a multi-layer medium grating structure, and a cascade grating structure of the medium grating and the metal grating. Wherein the color filter of the cascade grating structure both overcomes the low reflective efficiency of the medium grating, and reduces crosstalk of the metal grating, thus becoming a popular research direction of the grating-type color filter.

FIG. 1 shows an existing color filter of the cascade grating. As shown in the drawing, in this color filter 100, a medium grating layer 120 and a metal grating layer 130 are arranged on the substrate 110, wherein the metal grating layer 130 covers the ridge portion 121 and the groove portion 122 of this medium grating layer 120. When the frequency of an incident light forms guided-mode resonance with the cascade grating, this incident light can then be transmitted, while the light of other frequencies is reflected, thus achieving the filtering effect.

However, in this color filter of the grating structure, because the guided-mode resonance condition is strongly dependent on the incident angle of the incident light, i.e. the guided-mode resonance condition changes with the incident angle of the incident light, the transmission spectrum will move toward both sides to even disappear, which greatly limits application of the color filter in the actual production.

### SUMMARY OF THE INVENTION

The present invention seeks to provide a color filter of a reflective grating structure, and to reduce the influence of the incident angle of light on the resonance conditions by changing the structure of the color filter, so as to achieve the filtering effect within a relatively wide range of incident angle; while keeping the flatness of the surface, so as to improve the reflecting efficiency of the light.

In order to achieve a forementioned purpose, the present invention adopts the following technical solution:

A reflective color filter, comprising a medium grating layer, a metal layer, and a first medium layer, wherein the metal layer is set on the ridge portion, at least one side portion, and a part of the groove portion of the medium grating layer, said first medium layer is set on the medium grating layer and the metal layer.

Furthermore, a second medium layer is set on said medium grating layer and said metal layer, said second medium layer is covered by said first medium layer, the refractive index of said second medium layer is smaller than the refractive index of said first medium layer.

In another solution, a medium layer with multilayer structure is set on said medium grating layer and said metal layer, wherein said first medium layer belongs to said medium layer with multilayer structure.

In above technical solutions, said first medium layer has a refractive index greater than 1.65.

In further technical solution, an interval is arranged between the metal layer on the partial groove portion and at least one of the lateral portions on both sides of the groove.

Or, said metal layer is set at the ridge portion, the single lateral portion and the partial groove portion of the medium grating layer, wherein the metal layer on the partial groove portion is connected with that on the single lateral portion, and an interval is arranged between the metal layer on the partial groove portion and the other single lateral portion opposite to the single lateral portion with the metal layer.

In above technical solution, the area covered by the metal layer on the groove portion is 30% to 80% of the entire area of the groove portion.

In a preferred embodiment, the area covered by the metal layer on the groove portion is 70% of the entire area of the groove portion.

The material of said metal layer is one kind in aluminum, silver or copper.

With the above technical solutions, the present invention has the following advantages compared with the prior art:

Because a part of the medium grating layer is exposed through an opening of the metal layer on the groove portion, the resonance condition of the cascade grating is diminished, so that the influence of the incident angle on the resonance condition is reduced. In another aspect, because the reflective wave length relies on the period and duty ratio of the medium grating layer only, the entire color filter can have same thickness, so that the flatness of the surface is improved.

### BRIEF DESCRIPTION OF THE FIGURES

FIG. 1 shows the structure of an existing color filter of the cascade grating;

FIG. 2 shows a structural schematic diagram of the reflective color filter of the first embodiment of present invention;

FIG. 3A to 3C show the change of reflectivity of the three colors of red, green, blue with different incident angle in the first embodiment;

FIG. 4 shows the reflection spectrum of the green filter in the first embodiment with the change of the cover ratio of the metal layer;

FIG. 5 shows the reflection spectrum of the green filter in different incident angle in the first embodiment when the cover ratio of the metal layer is 0.3;

FIG. 6 shows the reflection spectrum of the green filter in different incident angle in the first embodiment when the cover ratio of the metal layer is 0.8;

FIG. 7 shows the reflection spectrum of the green filter in different thickness of the metal layer in the first embodiment;

FIG. 8 shows a structural schematic diagram of the reflective color filter of the second embodiment of present invention; and

FIG. 9 shows the reflection spectrum of the green filter in different incident angle in the second embodiment.

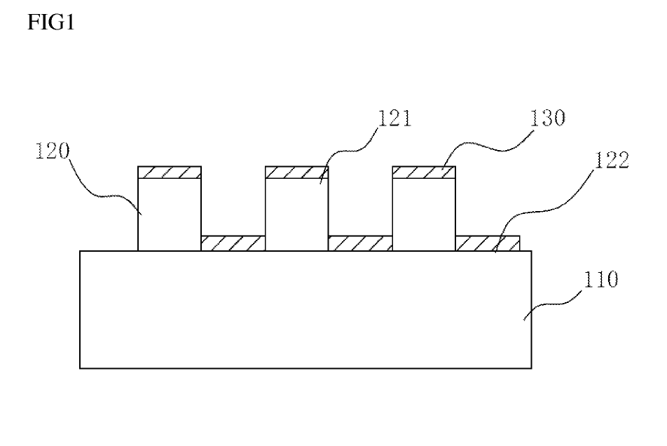

### DETAILED DESCRIPTION OF THE EMBODIMENTS

The present invention will be further described below:

### Embodiment 1

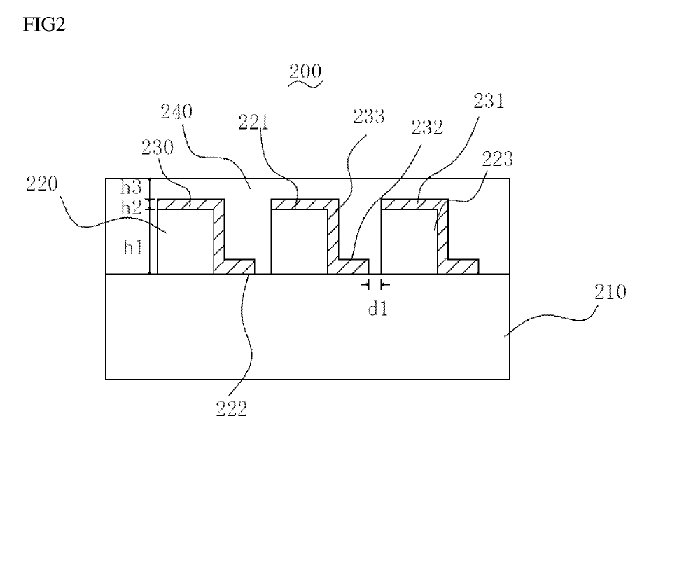

FIG. 2 is a structural schematic diagram of the reflective color filter of the present invention. As shown in the figure, the reflective color filter 200 comprises a substrate 210, a medium grating layer 220, a metal layer 230 and a first medium layer 240. Wherein, the material of the substrate 210 can be same with the material of the medium grating layer 220, so that the manufacture of the medium grating layer 220 will be more convenient. The medium grating layer 220 has a grating structure of periodic arrangement, including a ridge portion 221, a groove portion 222 and a lateral portion 223. The material of the metal layer 230 is one kind of aluminum, silver or copper. The metal layer has three segments: the metal layer segment 231 is set on the ridge portion 221 of the grating structure, the metal layer segment 233 is set on the lateral portion 223 of the grating structure, and the metal layer segment 232 is set on the groove portion 222 of the grating structure. Wherein the metal layer segment 232 only covers part of the groove portion 222, not the whole groove. The first medium layer 240 with a refractive index larger than 1.65 covers the metal layer 230 and part of the medium grating layer 220 exposed through the interval of the metal layer 230. The external light illuminates the surface of the first medium layer 240 and is reflected. Because of the coordinated effect of the medium grating lay 220, the metal layer 230, and the first medium layer 240, the portion in the incident light with the wave band which is complied with the resonance condition decided by the period and duty ratio of the grating structure in the medium grating layer 220 will be reflected, so achieving the effect of reflection filter.

Taking the most common red light filter, green light filter and blue light filter as an example. Table 1 gives the grating structure of the filters of the three colors:

TABLE 1
Parameters of the grating structure of the three
colors of light, red, green and blue (unit: nm)

| | h1: 260; h2: 60; h3: 20 | | |
|---|---|---|---|
| | P | f | λ |
| Red | 500 | 0.7 | 700 |
| Green | 500 | 0.35 | 540 |
| Blue | 350 | 0.4 | 470 |

Wherein h1 is the thickness of the medium grating layer 220, h2 is the thickness of the metal layer 230, h3 is the thickness of the first medium layer 240, P is the width of a single period of the medium grating, f is the duty ratio of the grating structure, and λ is the wavelength of the incident light. Above table shows that the filter effect to different colors of the reflective color filter in this invention is decided by the period P and the duty ratio f of the grating structure, that is to say, transversal structure parameter. When a large scale multi color filter for using on such as display devices is designed, only the transversal structure parameter should be controlled to form corresponding grating structure in the pixels, while the thickness remains unchanged. So the surface of the color filter is flat.

In one embodiment, the metal layer 230 is set on the ridge portion 221, the lateral portion 223 and part of the groove portion 222 of the medium grating layer 320, Wherein, the metal segment 232 on the groove portion 222 is connected to the metal segment 233 on the lateral portion 223, while an interval d1 is arranged on the other lateral portion opposite to the lateral portion 223 with metal segment. The metal layer 230 of this structure can be formed at a time on the medium grating 220 by oblique sputtering, which is more convenient. Or other more complicated method such as mask lithography can also be used, wherein the medium grating 220 is first plated with a layer of metal, and then the interval d1 is formed by etching with the photoresist. Also, the metal layer 230 can be set on the medium grating layer 220 with other distribution shaper, for example, form metal layer on both side of the lateral portion 223, or only form metal layer on any one side of the lateral portion. The metal segment 232 on the groove portion 222 can have interval with both lateral portions, or only have interval with one of the lateral portions, only be sure to have interval on the groove portion 222 so that part of the medium with relative low refractive index is exposed. That is to say, the location of the metal segment 232 on the groove portion 222 has little effect to the filter effect of this invention. Hereinafter it will be found that the cover ratio (the cover ratio is defined as the ratio of the area covered with the metal layer on the groove portion and the entire area of the groove portion) of the metal layer on the groove portion shows more effect to the filter effect of this invention.

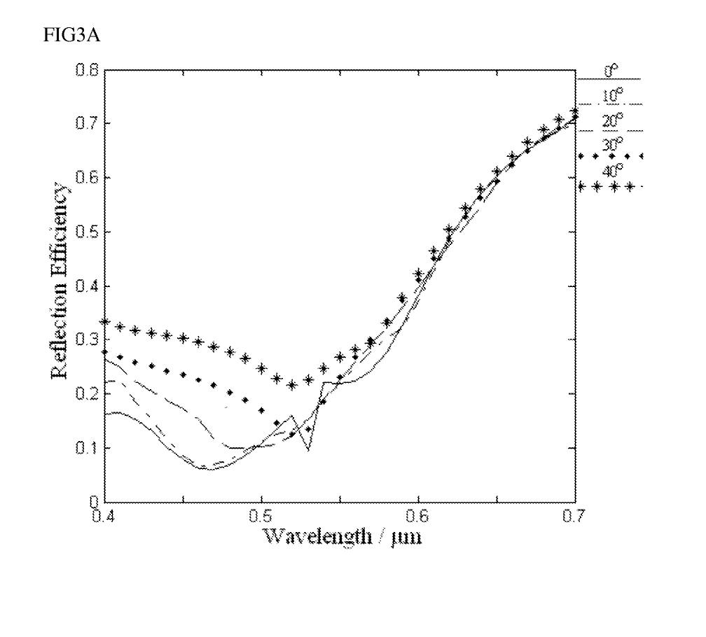

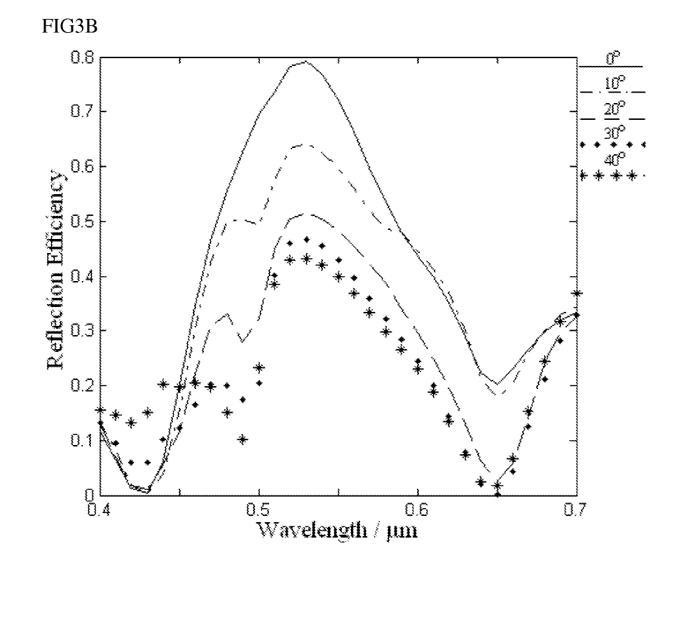

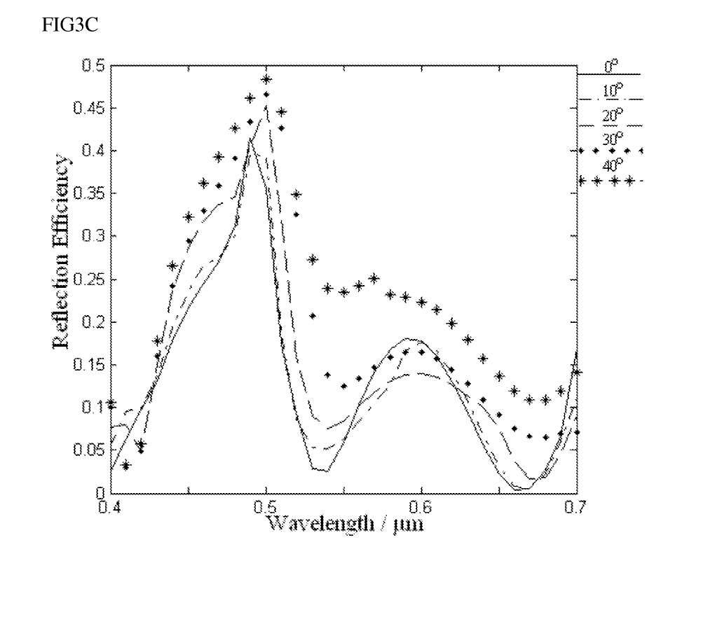

FIGS. 3A-3C show the change of the reflectivity of a light wave of the three colors in the example at different angles. As shown in the figures, when the incident angle changes from 0 degree to 40 degrees, there is only a slight change of the light at the respective maximum reflectivity of the three filters of red, green and blue light. These indicate that the filter in this embodiment can allow change within a wide range of angle, and achieve the filtering effect. Ant the principle to get such effect is rely on the non entire covering of the metal layer 230 on the medium grating layer 220, causing the reducing of the sensibility to the incident angle previously caused by the guide-mode resonance to the grating structure of metal and medium, so the shortage of the cascade grating is diminished.

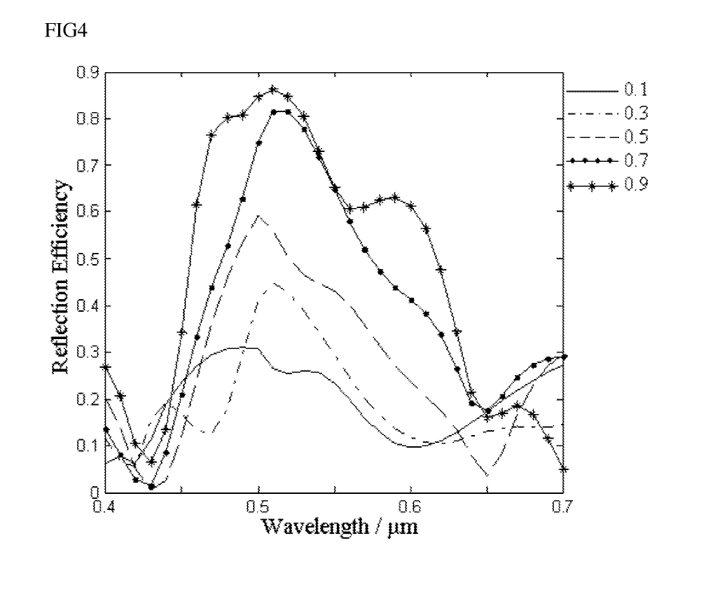

Furthermore, according to the green filter in this embodiment, define the ratio of the width of metal segment 232 and the width of the groove portion 222 to be f2, that is, the cover ratio of the metal layer is f2. While the cover ratio f2 of the metal layer 232 on the groove portion 222 increases from 0.1 to 0.9, the relative reflection spectrum is shown in FIG. 4. When f2 is 0.1, the efficiency of the reflection spectrum is quite low, and the secondary peak is larger, and when f2 is 0.9, the band width of the reflection spectrum is quite broad, when outputting three primary colors, it will cause the overlap of the spectrum of three colors, so to lower the purity of the color filter.

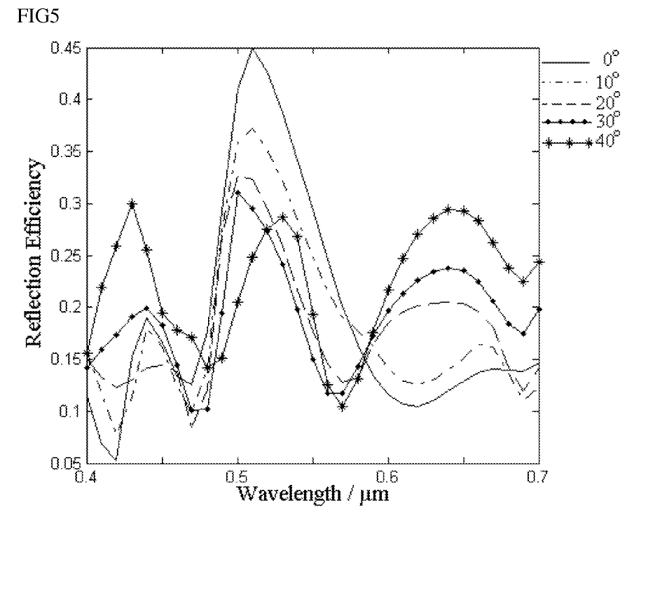

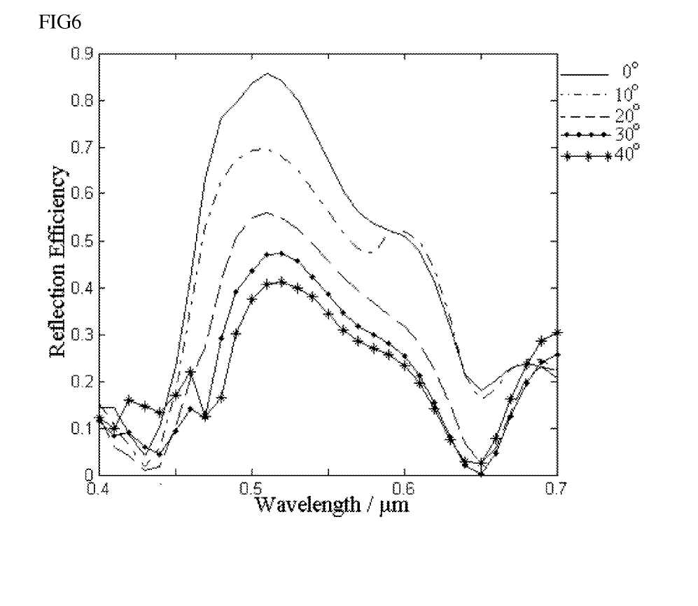

When f2 is 0.3, changing the incident angle from 0 degree to 40 degree, the reflection spectrum shows in FIG. 5. When the incident angle is larger than 30 degree, the vibration of the output spectrum is large, so the purity of the output spectrum is affected. When f2 is 0.8, the transparent spectrum shows in FIG. 6, with relative large incident angle, the vibration of the output spectrum can be omitted. So a cover ratio of 0.3<f2<0.8 should be selected.

A preferred embodiment has a cover ratio f2 of 0.7, the reflective spectrum has relative higher transmittance and good monochromaticity.

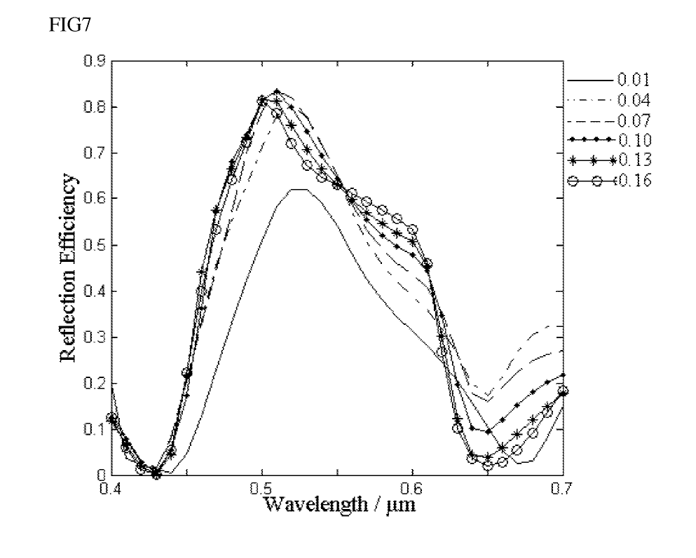

With the green filter in the embodiment, while the thickness h2 of 230 changes between 0.01 to 0.16 μm, the transmitted spectrum shows in FIG. 7. When the thickness is larger than 0.04 μm, the reflective effect is relatively larger, and the effect by the changes of thickness to the reflective effect and the location of the middle of the spectrum is small, but the increase of the thickness causes the increase of the band width of reflection spectrum.

### Embodiment 2

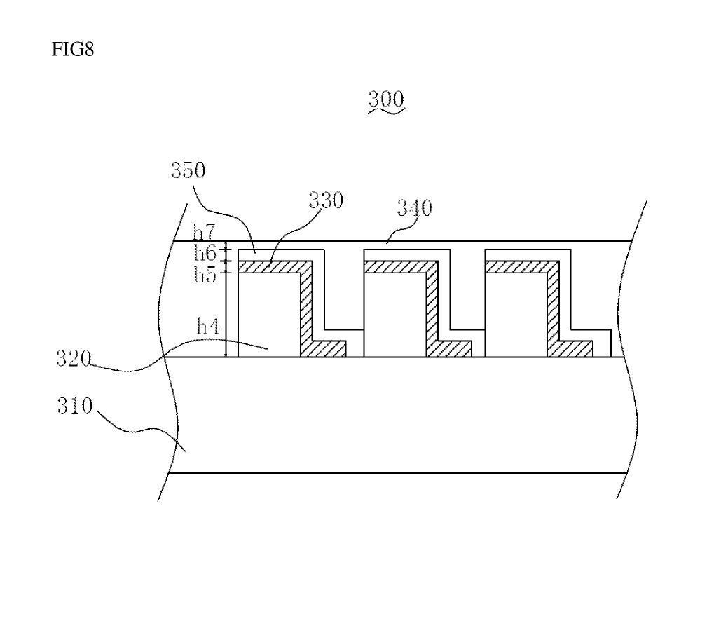

FIG. 8 is a structural schematic diagram of the reflective color filter of another embodiment in the present invention. As shown in the figure, the reflective color filter 300 also comprises a second medium layer 350, the second medium layer is set on the medium grating layer 320 and the metal layer 330 and covered by a first medium layer 340. The refractive index of the second medium layer is smaller than that of the first medium layer, having a portion filter effect, shows a sub-band suppression to both side of the wave band with the maximum reflectivity. Take green band as example. Table 2 gives the grating structure of the green filters in this embodiment:

TABLE 2
Parameters of the grating structure of the green (unit: nm)

| | h4: 260; h5: 40; h6: 20; h7: 20 | | |
|---|---|---|---|
| | P | f | λ |
| Green | 450 | 0.45 | 540 |

Wherein h4 is the thickness of the medium grating layer 320, h5 is the thickness of the metal layer 330, h6 is the thickness of the second medium layer 350, h7 is the thickness of the first medium layer 440, P is the width of a single period of the medium grating, f is the duty ratio of the grating structure, and λ is the wavelength of the incident light.

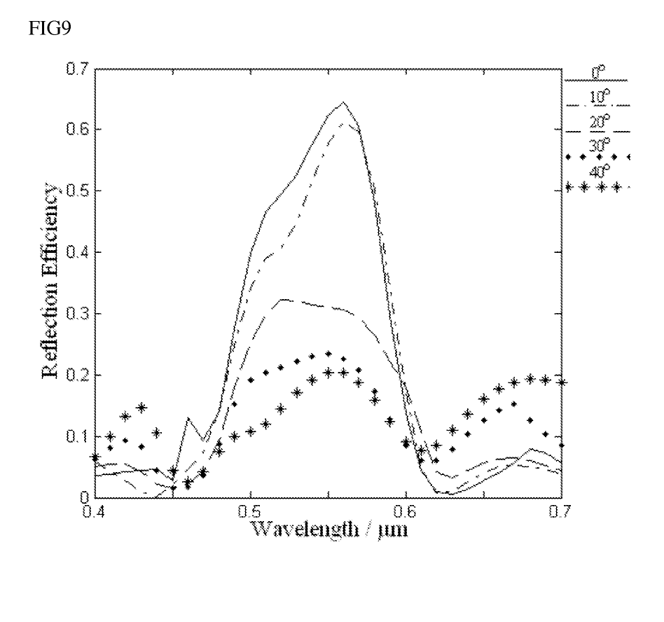

FIG. 9 shows the reflection spectrum of the green filter in different incident angle in the second embodiment. As shown in the figure, this kind of filtering grating can not only filter green light in reflective mode with a big scale of incident angle, but also have better monochromaticity than embodiment 1, so reduces the interference of the light of other band.

As the changed format, the second medium layer 350 can be replaced by a multi-layer structure, meanwhile the first medium layer can be one layer of the multi-layer structure.

In summary, this invention provides a reflective color filter, with a cascade structure consisted by a media grating layer, a color layer, and a high refraction index layer, so the surface of the filter has high flatness. Because a part of the medium grating layer is exposed through an opening of the metal layer on the groove portion, the angular sensitivity of the resonance output is reduced, and the influence of the incident angle on the resonance condition is diminished. Therefore, a reflection filtering can be realized in a wide angular area.

What is claimed is:

1. A reflective color filter, comprising a medium grating layer, a metal layer, and a first medium layer, wherein the metal layer is set on the ridge portion, at least one side portion, and a part of the groove portion of the medium grating layer, said first medium layer is set on the medium grating layer and the metal layer.

2. The reflective color filter according to claim 1, wherein a second medium layer is set on said medium grating layer and said metal layer, said second medium layer is covered by said first medium layer, the refractive index of said second medium layer is smaller than the refractive index of said first medium layer.

3. The reflective color filter according to claim 1, wherein a medium layer with multilayer structure is set on said medium grating layer and said metal layer, wherein said first medium layer belongs to said medium layer with multilayer structure.

4. The reflective color filter according to claim 1, claim 2, or claim 3, wherein said first medium layer has a refractive index greater than 1.65.

5. The reflective color filter according to claim 1, claim 2, or claim 3, wherein an interval is arranged between the metal layer on the partial groove portion and at least one of the lateral portions on both sides of the groove.

6. The reflective color filter according to claim 1, claim 2, or claim 3, wherein said metal layer is set at the ridge portion, the single lateral portion and the partial groove portion of the medium grating layer, wherein the metal layer on the partial groove portion is connected with that on the single lateral portion, and an interval is arranged between the metal layer on the partial groove portion and the other single lateral portion opposite to the single lateral portion with the metal layer.

7. The reflective color filter according to claim 1, claim 2, or claim 3, wherein the area covered by the metal layer on the groove portion is 30% to 80% of the entire area of the groove portion.

8. The reflective color filter according to claim 7, wherein the area covered by the metal layer on the groove portion is 70% of the entire area of the groove portion.

9. The reflective color filter according to claim 1, claim 2, or claim 3, wherein the material of said metal layer is one kind in aluminum, silver or copper.
